(19) United States
(12) Patent Application Publication
(10) Pub. No.: US 2026/0312046 A1
(43) Pub. Date: Oct. 8, 2026

(54) ANODE ACTIVE MATERIAL LAYER AND SODIUM-ION BATTERY

(71) Applicant: TOYOTA JIDOSHA KABUSHIKI KAISHA, Toyota-shi (JP)

(72) Inventors: Yosuke TOKUDA, Susono-shi (JP); Takayoshi KUBOTA, Toyota-shi (JP); Hiroo NOZAKI, Chiryu-shi (JP); Hideyuki YAMAMURA, Susono-shi (JP)

(73) Assignee: TOYOTA JIDOSHA KABUSHIKI KAISHA, Toyota-shi (JP)

(21) Appl. No.: 19/457,522

(22) Filed: Jan. 23, 2026

(30) Foreign Application Priority Data
Apr. 3, 2025 (JP) 2025-061807

(51) Int. Cl. H01M 4/583; H01M 4/02; H01M 10/054

(52) U.S. Cl. CPC H01M 4/583; H01M 10/054; H01M 2004/021; H01M 2004/027

(57) ABSTRACT

An anode active material layer according to the present disclosure contains a foamed metal layer and phosphorus-containing anode active material particles, the anode active material particles are supported in pores of the foamed metal layer, and the foamed metal layer includes a polyhedron skeletal structure in which a smallest angle between two adjacent faces of the polyhedron is 55° to 180°. A method for producing the anode active material layer according to the present disclosure includes applying a slurry containing the phosphorus-containing anode active material particles to the foamed metal layer that includes a polyhedron skeletal structure and drying the foamed metal layer, and pressing the foamed metal layer in the thickness direction, such that the smallest angle between two adjacent faces of the polyhedron is 55° to 180°, in this order.

### CROSS-REFERENCE TO RELATED APPLICATION

This application claims priority to Japanese Patent Application No. 2025-061807 filed on Apr. 3, 2025. The disclosure of the above-identified application, including the specification, drawings, and claims, is incorporated by reference herein in its entirety.

### BACKGROUND

### 1. Technical Field

The present disclosure relates to an anode active material layer and a sodium-ion battery.

### 2. Description of Related Art

Japanese Unexamined Patent Application Publication No. 2003-308831 (JP 2003-308831 A) discloses a non-aqueous electrolyte secondary battery including a cathode, an anode, and a non-aqueous electrolyte, in which the anode that is used is an electrode in which a current collector, having a three-dimensional structure, is filled with an anode material containing a composite made of a material containing an element capable of forming an alloy with lithium and a conductive material.

Japanese Unexamined Patent Application Publication No. 2012-186160 (JP 2012-186160 A) discloses a secondary battery that uses one type of anode metal selected from a group consisting of alkali metals, alkaline earth metals, and aluminum for an anode, uses an oxide, sulfide, or a mixture of these as a cathode active material, and that uses an aluminum porous material having a three-dimensional net-like structure as a cathode current collector.

### SUMMARY

When phosphorus-containing anode active material particles are used in a sodium-ion battery, the anode active material exhibits intercalation of sodium ions and expands significantly during charging, resulting in a significant increase in thickness of an anode active material layer as well.

In order to suppress increase in the thickness of the anode active material layer, it is conceivable to reduce the content of the anode active material particles in the anode active material layer, or the like, for example. However, reducing the content of the anode active material particles may reduce the charge capacity during charging of the anode active material layer.

An object of the present disclosure is to provide an anode active material layer that achieves both good charge capacity and suppressed expansion during charging of the anode active material layer, a sodium-ion battery using the anode active material layer, and a method for manufacturing the anode active material layer.

The present disclosers have found that the above object can be achieved by the following means.

### Aspect 1

An anode active material layer containing
a foamed metal layer, and phosphorus-containing anode active material particles, in which
the anode active material particles are supported in pores of the foamed metal layer, and
the foamed metal layer includes a polyhedron skeletal structure in which a smallest angle between two adjacent faces of the polyhedron is 55° to 180°.

### Aspect 2

The anode active material layer according to Aspect 1, in which a smallest angle between two adjacent faces of the polyhedron is 55° to 110°.

### Aspect 3

The anode active material layer according to Aspect 1 or 2, in which a Young's modulus of the foamed metal layer is greater than a Young's modulus of the anode active material particles.

### Aspect 4

A sodium-ion battery including the anode active material layer according to any one of Aspects 1 to 3, an electrolyte layer, and a cathode active material layer, in this order.

### Aspect 5

A method for manufacturing an anode active material layer, the method including
(A) impregnating a foamed metal layer that includes a polyhedron skeletal structure with a slurry containing phosphorus-containing anode active material particles, and drying the foamed metal layer, and
(B) obtaining the anode active material layer such that a smallest angle between two adjacent faces of the polyhedron is 55° to 180°,
in this order.

According to the present disclosure, an anode active material layer that achieves both good charge capacity and suppressed expansion during charging of the anode active material layer, a sodium-ion battery using the anode active material layer, and a method for manufacturing the anode active material layer, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a skeletal structure 1 of a foamed metal layer and anode active material particles 2 in an anode active material layer according to an embodiment of the present disclosure;

FIG. 2 is a schematic diagram illustrating a skeletal structure 1 of a foamed metal layer and anode active material particles 2 in an anode active material layer that differs from the embodiment of the present disclosure;

FIG. 3 is a schematic diagram illustrating a skeletal structure 1 of a foamed metal layer and silicon-based anode active material particles 3 in an anode active material layer that further differs from the embodiment of the present disclosure;

FIG. 4 is a schematic diagram of a polyhedron structure 5 serving as the skeletal structure of a foamed metal layer;

FIG. 5 is a schematic diagram of a sodium-ion battery 100 according to an embodiment of the present disclosure; and

FIG. 6 is a graph showing a relation between a dihedral angle (°) of a foamed metal layer and a coefficient of expansion of the anode active material layer when the sodium ion battery using the anode active material layer of each example is charged and discharged.

### DETAILED DESCRIPTION OF EMBODIMENTS

An embodiment of the present disclosure will be described below in detail. Note that the present disclosure is not limited to the embodiment described below, and various modifications can be carried out within the spirit and scope of the present disclosure.

### 1. Anode Active Material Layer

An anode active material layer of the present disclosure contains a foamed metal layer and phosphorus-containing anode active material particles. The anode active material particles are supported in pores of the foamed metal layer. The foamed metal layer has a polyhedral skeletal structure, and also the smallest angle between two adjacent faces of the polyhedron is 55° to 180°.

For example, in a sodium ion battery, employing an anode active material layer, in which phosphorus-containing anode active material particles are supported in the pores of a conductive foamed metal layer, has been studied.

From the perspective of improving charge density of the sodium-ion battery, it is conceivable to make the thickness of the anode active material layer smaller by pressing, after the anode active material particles are supported on the foamed metal layer. The phosphorus-containing anode active material particles are generally soft and deformed by pressing, so as to fit into corner regions of a metal skeletal structure of the foamed metal layer, i.e., into corner portions formed by two adjacent faces of the polyhedron metal skeletal structure. In such an anode active material layer, the anode active material particles expand during charging and discharging, forcing open the corner region of the metal skeletal structure of the foamed metal layer, resulting in expansion of the anode active material layer. The phosphorus-containing anode active material particles expand particularly greatly during charging, and accordingly the expansion of the anode active material layer also becomes significant.

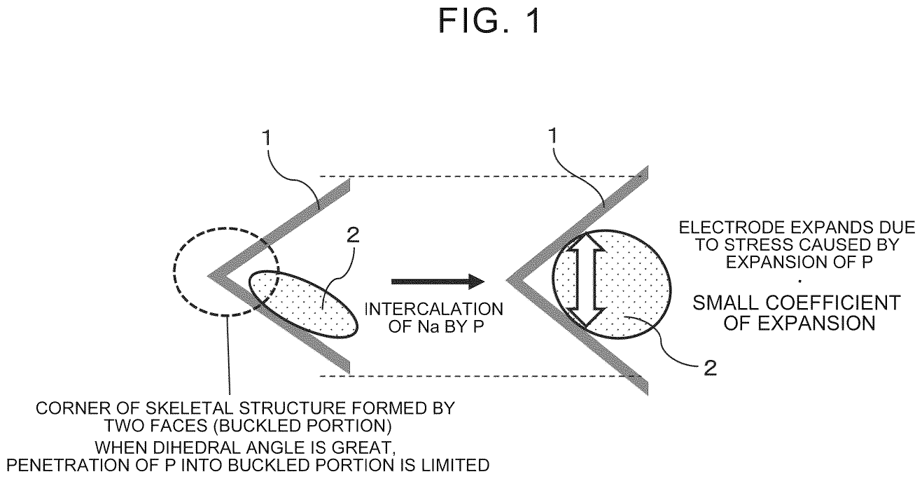

In the anode active material layer according to the present disclosure, the smallest angle between two adjacent faces of the polyhedral skeletal structure of the foamed metal layer is 55° to 180°. As illustrated in FIG. 1, when the angle formed between two adjacent faces of the polyhedral skeletal structure 1 is such a relatively large angle, the phosphorus-containing anode active material particles 2 do not readily enter the corner regions of the skeletal structure 1 of the foamed metal layer. Accordingly, the corner regions of the foamed metal layer are less readily forced open by the expansion of the phosphorus-containing anode active material particles 2 during charging.

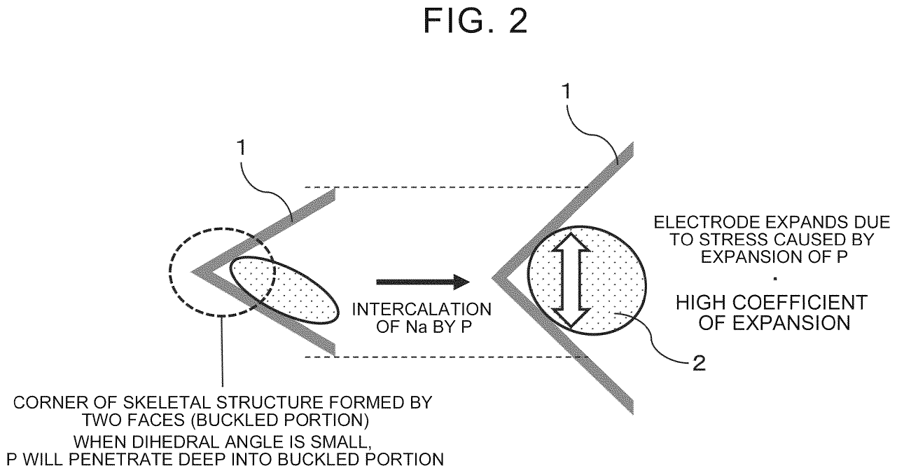

In contrast, as illustrated in FIG. 2, when the smallest angle between two adjacent faces of the polyhedral skeletal structure 1 is smaller than 55°, the phosphorus-containing anode active material particles 2 readily enter the corner regions of the skeletal structure 1 of the foamed metal layer, and the corner regions of the foamed metal layer are readily forced open during charging.

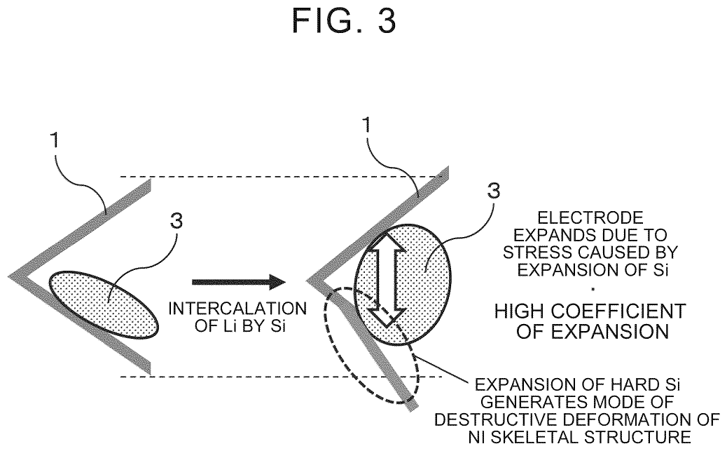

Note that as illustrated in FIG. 3, when silicon-based active material particles 2, such as Si particles, for example, are used as anode active material particles in a lithium ion battery, the silicon-based active material particles 2 have high rigidity and therefore do not readily enter into the corner regions of the skeletal structure 1 of the foamed metal layer. However, the expansion of the silicon-based active material particles during charging destroys the skeletal structure 1 of the foamed metal layer.

Accordingly, it should be recognized that the technical problem of the present disclosure is a problem specific to a configuration in which phosphorus-containing anode active material particles are supported on a foamed metal layer, and is in particular a problem specific to sodium-ion batteries.

### 1-1. Foamed Metal Layer

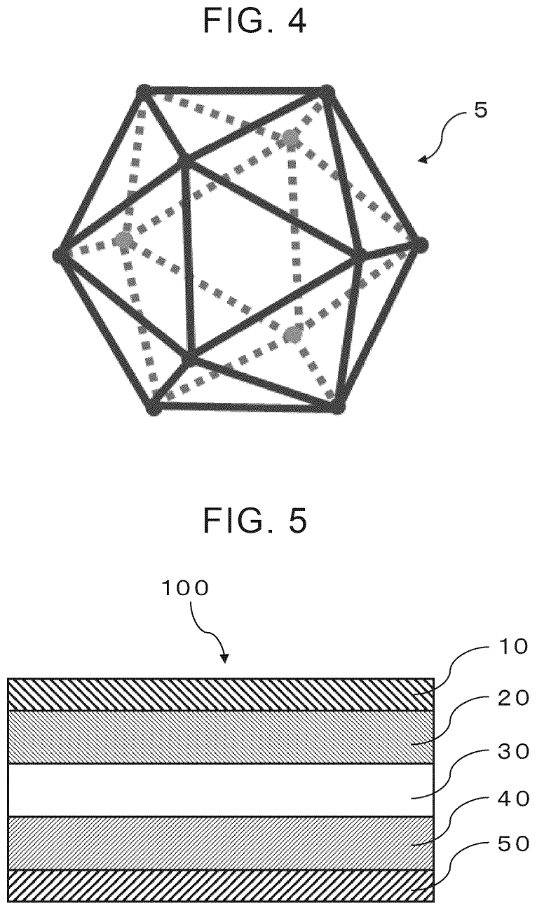

The foamed metal layer used in the anode active material layer of the present disclosure has a polyhedral skeletal structure in which the smallest angle between two adjacent faces of the polyhedron is 55° to 180°. Here, the skeletal structure of the foamed metal layer, i.e., the porous structure of the foamed metal, is ideally a structure in which regular icosahedrons 5 such as illustrated in FIG. 4 are connected, with the metal skeletal structures disposed on the ridge lines.

The smallest angle between two adjacent faces of the polyhedron may be 55° or greater, 65° or greater, 75° or greater, or 85° or greater. The angle may be 180° or smaller, 150° or smaller, 110° or smaller, or 70° or smaller. It is particularly preferable that the smallest angle between two adjacent faces of the polyhedron is 55° to 110°.

Examples of materials for the foamed metal layer include Ni or Ni alloy, iron, stainless steel, and so forth. These metals have a high Young's modulus, and even when the phosphorus-containing anode active material particles expand during charging, the corner regions of the foamed metal layer are particularly not readily forced open.

The Young's modulus of the foamed metal layer is preferably greater than the Young's modulus of the phosphorus-containing anode active material particles. The Young's modulus of the material of the foamed metal layer is preferably 180 GPa to 250 GPa. The Young's modulus of the material of the foamed metal layer may be 180 GPa or more, 185 GPa or more, 190 GPa or more, or 195 GPa or more. The Young's modulus of the material of the foamed metal layer may be 250 GPa or less, 240 GPa or less, 230 GPa or less, 220 GPa or less, or 210 GPa or less.

The thickness of the foamed metal layer may be, for example, 0.45 mm to 1.5 mm. The thickness of the foamed metal layer may be 0.45 mm or more, 0.5 mm or more, 0.6 mm or more, 0.8 mm or more, or 0.9 mm or more. The thickness of the foamed metal layer may be 1.5 mm or less, 1.4 mm or less, 1.3 mm or less, or 1.2 mm or less.

### 1-2. Anode Active Material Particles

The anode active material particles used in the anode active material layer according to the present disclosure are anode active material particles containing phosphorus.

The anode active material particles can be made using, for example, phosphorus, more specifically red phosphorus, a phosphorus compound, or the like. The anode active material particles can be, for example, elemental phosphorus or a composite material of phosphorus and carbon. Examples of composite materials of phosphorus and carbon include a mixture of red phosphorus and acetylene black, although not limited thereto in particular.

The anode active material particles containing phosphorus are preferably supported on a foamed metal layer. The coating weight of the anode active material particles in the foamed metal layer may be 5 mg/cm² to 50 mg/cm². The coating weight of the anode active material particles in the foamed metal layer may be 5 mg/cm² or more, 10 mg/cm² or more, or 15 mg/cm² or more. The coating weight of the anode active material particles in the foamed metal layer may be 50 mg/cm² or less, 40 mg/cm² or less, 30 mg/cm² or less, or 20 mg/cm² or less.

### 2. Sodium-Ion Battery

As illustrated in FIG. 5, the sodium-ion battery 100 according to the present disclosure includes, for example, an anode current collector layer 10, the anode active material layer 20 according to the present disclosure, an electrolyte layer 30, a cathode active material layer 40, and a cathode current collector layer 50, in this order. Here, when the anode active material layer 20 and/or the cathode active material layer 40 uses a conductive material, for example, a foamed metal layer, the foamed metal layer can also serve as a current collector. In this case, the anode current collector layer 10 and/or the cathode current collector layer 50 are optional configurations.

The sodium-ion battery according to the present disclosure may be a liquid sodium ion battery, specifically a sodium ion battery using an aqueous or non-aqueous electrolyte, or an all-solid-state sodium-ion battery. The sodium ion battery of the present disclosure may also be a sodium-ion secondary battery.

### 2-1. Electrolyte Layer

The electrolyte layer 30 is a layer that is formed between the anode active material layer 20 and the cathode active material layer 40. The electrolyte layer 30 enables ionic conduction between the cathode active material and the anode active material via an electrolyte contained therein. The form of the electrolyte layer 30 is not limited in particular, and examples thereof can include a liquid electrolyte layer, a gel electrolyte layer, a solid electrolyte layer, and so forth.

The liquid electrolyte layer is typically a layer made using a non-aqueous electrolyte solution. The non-aqueous electrolyte typically contains a sodium salt and a non-aqueous solvent. Examples of sodium salts include inorganic sodium salts such as NaPF₆, NaBF₄, NaClO₄, NaAsF₆, and so forth; and organic sodium salts and so forth such as NaCF₃SO₃, NaN(CF₃SO₂)₂, NaN(C₂F₅SO₂)₂, NaN(FSO₂)₂, NaC(CF₃SO₂)₃, and so forth.

The non-aqueous solvent is not limited in particular, as long as the sodium salt is dissolved therein. Examples of high dielectric constant solvents include cyclic esters (cyclic carbonates) such as ethylene carbonate (EC), propylene carbonate (PC), butylene carbonate (BC), and so forth, and γ-butyrolactone, sulfolane, N-methylpyrrolidone (NMP), 1,3-dimethyl-2-imidazolidinone (DMI), and so forth. On the other hand, examples of low-viscosity solvents include linear esters (linear carbonates) such as dimethyl carbonate (DMC), diethyl carbonate (DEC), ethyl methyl carbonate (EMC), and so forth, acetates such as methyl acetate, ethyl acetate, and so forth, and ethers such as 2-methyltetrahydrofuran and so forth. A mixed solvent, in which a high dielectric constant solvent and a low viscosity solvent are mixed, may also be used.

The concentration of the sodium salt in the non-aqueous electrolyte solution is, for example, in a range of 0.3 mol/L to 5 mol/L, and preferably in a range of 0.8 mol/L to 1.5 mol/L. This is because when the concentration of the sodium salt is too low, there is a possibility that the capacity will decrease at high rates, and when the concentration of the sodium salt is too high, there is a possibility that viscosity will increase, resulting in a decrease in capacity at low temperatures. Note that a low-volatility liquid such as an ionic liquid or the like, for example, may be used as the non-aqueous electrolyte.

The gel electrolyte layer can be obtained by adding a polymer to a non-aqueous electrolyte solution to form a gel, for example. Specifically, gelation can be achieved by adding a polymer such as polyethylene oxide (PEO), polyacrylonitrile (PAN), polymethyl methacrylate (PMMA), or the like, to the non-aqueous electrolyte.

The solid electrolyte layer is a layer made using a solid electrolyte. The solid electrolyte is not limited in particular as long as it has Na ion conductivity, and examples thereof include the aforementioned NaMH compound, known oxide solid electrolytes, sulfide solid electrolytes, and so forth.

### 2-2. Cathode Active Material Layer

The cathode active material layer 40 contains at least a cathode active material. Further, a conductive material, a binder, and a solid electrolyte can be optionally contained. For these materials, those typically used in sodium-ion batteries may be used.

### 2-3. Current Collector Layer

In the cathode active material layer 40, the cathode current collector layer 50 is usually disposed on the face of the cathode active material layer 40 that is not on the electrolyte layer 30 side. Examples of materials for the cathode current collector layer 50 include stainless steel, aluminum, nickel, iron, titanium, carbon, and so forth. Examples of the form of the cathode current collector layer 50 include forms such as a foil, a mesh, a porous material, and so forth. A cathode can be easily produced by laminating the cathode current collector layer 50 on the cathode active material layer 40 that is described above. Note, however, that depending on the material contained in the cathode active material layer 40, there are cases in which the cathode current collector layer 50 can be omitted. In this case, the cathode active material layer 40 itself serves as the cathode.

The anode active material layer 20 is usually provided with the anode current collector layer 10 on the face of the anode active material layer 20 that is not on the electrolyte layer 30 side. Examples of materials for the anode current collector layer 10 include stainless steel, aluminum, nickel, copper, carbon, and so forth. Examples of the form of the anode current collector layer 10 include forms such as a foil, a mesh, a porous material, and so forth. An anode can be easily produced by laminating the anode current collector layer 10 on the anode active material layer 20 that is described above. However, the anode active material layer 20 according to the present disclosure has a foamed metal layer, and accordingly the anode current collector layer 10 may be omitted.

### 2-3. Other Configurations

A battery case used for the sodium-ion battery 100 can be any general battery case and is not limited in particular. Also, the sodium-ion battery 100 may be a primary battery or a secondary battery, but is preferably a secondary battery, in order to more effectively exhibit advantages of improved durability.

### 3. Method for Producing Anode Active Material Layer

A method for producing an anode active material layer according to the present disclosure includes
(A) impregnating a foamed metal layer that has a polyhedral skeletal structure with a slurry containing phosphorus-containing anode active material particles, and drying the foamed metal layer, and
(B) obtaining an anode active material layer such that the smallest angle between two adjacent faces of the polyhedron is 55° to 180°, in this order.

### 3-1. Step A

Step A is impregnating a foamed metal layer that has a polyhedral skeletal structure with a slurry containing phosphorus-containing anode active material particles, and drying the foamed metal layer.

The slurry can be prepared using a mixture obtained by dispersing phosphorus-containing anode active material particles in an organic solvent. For the organic solvent, N-methylpyrrolidone (NMP), for example, can be used.

The foamed metal layer may be impregnated with the slurry by a known method, such as for example, coating, dipping, or the like.

### 3-2. Step B

Step B is pressing the foamed metal layer in a thickness direction of the foamed metal layer, for example, so as to obtain an anode active material layer, such that the smallest angle between two adjacent faces of the polyhedron is 55° to 180°. When the smallest angle between two faces of the foamed metal layer used in step A is 55° to 180°, step B may be completed without pressing, for example.

The smallest angle between two adjacent faces of the polyhedron can be adjusted by calculation, for example, from the ratio of the thickness of the foamed metal layer to the thickness before pressing and the shape of the polyhedron.

For example, when the skeletal structure of the foamed metal layer, i.e., the porous structure of the foamed metal, is considered to be a structure of the regular icosahedrons 5 that are connected, as illustrated in FIG. 4, the angle between two adjacent faces of the polyhedron, i.e., the dihedral angle, is approximately 138°. Therefore, when the foamed metal layer is pressed to a thickness that is two-thirds of the original thickness, the smallest dihedral angle is calculated to be 92°.

3-3. Other processes

After step B, the method may further include vacuum drying the foamed metal layer. The vacuum drying may be carried out, for example, for 12 to 36 hours, preferably 24 hours, at 100° C. to 200° C., preferably 120° C.

### 4. Examples

### 4-1. Examples 1 to 4 and Comparative Example 1

### 4-1-1. Example 1

Red phosphorus (Japan Pure Chemical Co., Ltd.) and acetylene black (Li-400, DENKA) were used as raw materials, and were weighed out to a total of 5 g in a mass ratio of 7:3. These were mixed in a mortar, then placed in a ball mill pot together with 96 g of 5 mm diameter zirconia balls, and after replacing the atmosphere with Ar gas, the pot was sealed and subjected to ball milling to obtain a P/C composite material. The ball milling conditions were 500 rpm for 24 hours.

The obtained P/C composite material was weighed out in a mass ratio of P/C composite material:CNT:PVDF=93:1:6, and dispersed and mixed in NMP to form a slurry. This slurry was applied to a 1.2 mm thick foamed Ni (Celmet, Sumitomo Electric Industries) and dried. Thereafter, the electrode was dried in vacuum at 120° C. overnight to obtain a sample electrode. The coating weight of the P/C composite material on the foamed Ni was 10 mg/cm². This electrode was evaluated using a CR2032 type coin cell.

A metallic Na foil was used as the counter electrode. The electrolytic solution that was used was 1M NaPF₆ (EC:DEC=1:1 vol, FEC 3 wt %). The evaluation was carried out in a thermostatic chamber at 25° C., with a voltage range of 0.01 to 2.0 V and a rate of 0.1 C. The charge capacity of the battery was calculated based on the mass of P in the electrode. In this experiment, the reaction of intercalation of Na by P is referred to as charging, and the reaction of deintercalation of Na is referred to as discharging.

The thickness of the electrode before and after the first charge was measured using a constant pressure thickness measuring instrument (Teclock, PG-15A), and the coefficient of expansion of the electrode was calculated. The coefficient of expansion is indicated as a ratio when the thickness before the first charge is set to 1.00.

### 4-1-2. Examples 2 to 4 and Comparative Example 1

For Examples 2 to 4 and Comparative Example 1, before vacuum drying, the foamed Ni having a thickness of 1.2 mm before pressing was pressed to the following thicknesses, and the smallest angle formed between two adjacent faces of the skeletal structure of the foamed Ni was adjusted. Note that the skeletal structure of the foamed Ni, i.e., the pores, ideally have a structure of connected regular icosahedrons as illustrated in FIG. 4. Note that the dihedral angle of a regular icosahedron is approximately 138°.
Example 2: Foamed Ni thickness=0.80 mm, dihedral angle=92°
Example 3: Foamed Ni thickness=0.60 mm, dihedral angle=69°
Example 4: Foamed Ni thickness=0.48 mm, dihedral angle=55°
Comparative Example 1: Foamed Ni thickness=0.40 mm, dihedral angle=46°

### 4-2. Results

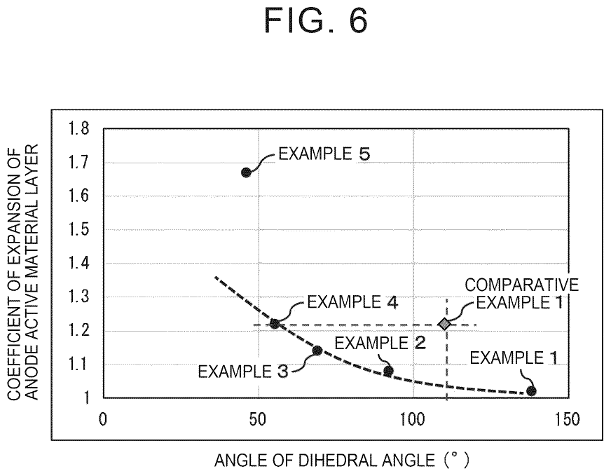

The results are summarized in Table 1 and FIG. 6.

TABLE 1

| | | Specific capacity at | |
|---|---|---|---|
| | Dihedral angle | first charge | Coefficient of |
| Example | (°) | (mAh/g-P) | expansion |
| Example 1 | 138 | 2011 | 1.02 |
| Example 2 | 92 | 1980 | 1.08 |
| Example 3 | 69 | 2001 | 1.14 |
| Example 4 | 55 | 1990 | 1.22 |
| Comparative | 46 | 1963 | 1.67 |
| Example 1 | | | |

From Table 1 and FIG. 6, in Examples 1 to 4 in which the dihedral angle was 55° or greater, the coefficient of expansion was 1.22 (Example 4) or less. In contrast, in Comparative Example 1 in which the dihedral angle was 46°, the coefficient of expansion was 1.67, and the thickness of the anode active material layer increased significantly after charging.

What is claimed is:

1. An anode active material layer containing
a foamed metal layer, and phosphorus-containing anode active material particles, wherein
the anode active material particles are supported in pores of the foamed metal layer, and
the foamed metal layer includes a polyhedron skeletal structure in which a smallest angle between two adjacent faces of the polyhedron is 55° to 180°.

2. The anode active material layer according to claim 1, wherein a smallest angle between two adjacent faces of the polyhedron is 55° to 110°.

3. The anode active material layer according to claim 1, wherein a Young's modulus of the foamed metal layer is greater than a Young's modulus of the anode active material particles.

4. A sodium-ion battery comprising:
the anode active material layer according to claim 1; an electrolyte layer; and a cathode active material layer, in this order.

5. A method for producing an anode active material layer, the method comprising:
(A) applying a slurry containing phosphorus-containing anode active material particles to a foamed metal layer that includes a polyhedron skeletal structure and drying the foamed metal layer; and
(B) obtaining the anode active material layer such that a smallest angle between two adjacent faces of the polyhedron is 55° to 180°,
in this order.
